(19) United States
(12) Patent Application Publication
(10) Pub. No.: US 2026/0079745 A1
(43) Pub. Date: Mar. 19, 2026

(54) DISTRIBUTED SYSTEM BATCH JOB TASK EXECUTION SCHEDULING

(71) Applicant: Verizon Patent and Licensing Inc., Basking Ridge, NJ (US)

(72) Inventors: Kabilan Kumaravelu, Erode (IN); Ramkumar Narasimhachary, Chennai (IN); Sravanth Devi, Chennai (IN); Altaf Mohammad, Hyderabad (IN)

(21) Appl. No.: 18/889,512

(22) Filed: Sep. 19, 2024

(51) Int. Cl. G06F 9/48

(52) U.S. Cl. CPC G06F 9/4881

(57) ABSTRACT

A system includes a task queue that stores multiple tasks of a batch job, and a scheduler. The scheduler includes multiple scheduler nodes which, on a first-come, first-served basis during a first interval, write their network address and port number to a same memory location of a shared memory storage, while overwriting any previous network address and port number written to the same memory location. A last one of the multiple scheduler nodes to write its network address and port number to the same memory location during the first interval is designated as a first primary scheduler and commands an execution system to perform task execution upon a first task of the batch job stored in the task queue.

### BACKGROUND

A distributed system, at its most basic, involves a group of computers working together so as to appear as a single computer to a system end-user. Computers of the distributed system have a shared state, operate concurrently, and can fail independently. Distributed systems enable both horizontal and vertical scaling. Horizontal scaling involves adding more computers to the distributed system. Vertical scaling involves upgrading the hardware of existing computers in the distributed system. Distributed systems also have the qualities of fault tolerance and low latency. A microservices architecture is one type of distributed system in which an application may be decomposed into separate components or services for execution by distributed computers. In a microservices architecture, each application is divided into distinct tasks and services, and each task or service is created independently and is executed as a unique process.

### BRIEF DESCRIPTION OF THE DRAWINGS

FIG. 1 depicts an example network environment in which batch job task execution is implemented in a distributed environment involving multiple scheduling nodes;

FIG. 2 illustrates the inter-operation of the components of a distributed system for scheduling execution of tasks of a batch job;

FIG. 3 is a diagram that depicts example components of a network device;

FIG. 4 illustrates an example process for initializing scheduler nodes of the scheduler system and the shared memory;

FIGS. 5-7 illustrate examples associated with the process of FIG. 4;

FIG. 8 illustrates an example process for prioritizing the operation of scheduler nodes for executing tasks of a batch job for an interval x that occurs after a first interval; and

FIGS. 9-12 illustrate examples associated with the process of FIG. 8.

### DETAILED DESCRIPTION OF THE PREFERRED EMBODIMENTS

The following detailed description refers to the accompanying drawings. The same reference numbers in different drawings may identify the same or similar elements. The following detailed description does not limit the invention.

Currently, distributed systems, including microservices, have the ability to service a multitude of requests, accumulate or generate data with respect to each of the requests, and respond with the client-needed results or resources. The accumulated data may then be processed by asynchronous jobs or threads. In a distributed system environment, multiple instances can have threads processing the same data. This imposes limitations on resource utilizations, data access, and duplicate read/write operations that can result in an invalid state or non-functional results. A scheduler microservice or the batch job can typically execute without a problem when handling static incoming traffic. However, when there is a spike or surge in incoming traffic, the scheduler microservice may clog, resulting in a stale, unresponsive state. This can negatively impact any batch job that the clogged scheduler microservice is handling/processing. In order to resolve this stale state of the scheduler microservice, an immediate, manual restart with vertical scaling is usually required. Further, horizontal scaling cannot be used to resolve the stale state since the scheduler microservice needs to be a single instance. Distributed systems, therefore, have a number of limitations when handling batch jobs, including no horizontal scaling because of a single instance requirement, manual scaling and maintenance, and non-resilience.

Exemplary implementations described herein implement multiple scheduler nodes in a scheduler system, where the multiple scheduler nodes, on a first-come, first-served basis, write their host network address and port number (e.g., host:port) into a same location of a memory storage (referred to herein as a “shared memory”), access to which is shared among the multiple scheduler nodes. When all of the multiple scheduler nodes have written their host network address and port number into the shared memory (referred to herein as “updating the shared memory”), overwriting any previously written host network address and port number, the last scheduler node that stored its network address and port number in the shared memory is designated as the “primary scheduler. ” The primary scheduler proceeds to send a command to the execution system to retrieve a next task of a batch job from the task queue and to execute the task. This process of updating the shared memory by the multiple scheduler nodes, excluding scheduler nodes that are currently involved in executing a task of the batch job, is repeated over multiple intervals until all of the tasks of the batch job are completed. The operation of the distributed system, using the multiple scheduler nodes and the shared memory as described herein, satisfies the above-noted guidelines for batch jobs in a distributed environment that doesn't require horizontal scaling, or manual scaling or maintenance, and is resilient.

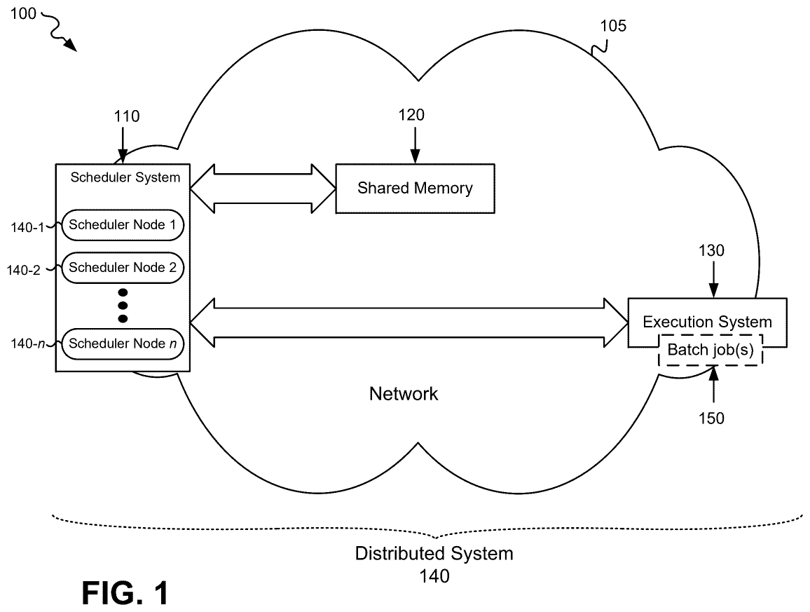

FIG. 1 depicts an example network environment 100 in which batch job task execution is implemented in a distributed environment involving multiple scheduling nodes, as described further herein. Network environment 100 may include a network 105, a scheduler system 110, a shared memory 120, and an execution system 130. As shown, scheduler system 110, shared memory 120, and execution system 130 are components of a distributed system 140 in which each of the components may be located at different geographic locations with respect to one another and with respect to network 105. Thus, scheduler system 110 may be located at a first location, shared memory 120 may be located at a second location, and execution system 130 may be located at a third location, where the first, second, and third locations are different geographically and have different connections to network 105.

Network 105 may include one or more networks of various types including, for example, a wireless network, a Public Switched Telephone Network (PSTN), a Local Area Network (LAN), a wide area network (WAN), a metropolitan area network (MAN), an intranet, and/or the Internet. The wireless network may include a Public Land Mobile Network (PLMN) and/or a wireless LAN or WAN (e.g., Wi-Fi).

Scheduler system 110 (referred to herein as “scheduler system” or “scheduler”) may include multiple (n) scheduler nodes 140-1 through 140-n that operate, as described in further detail herein, to schedule the execution of tasks in a batch job(s) 150 at execution system 130. Each of the n scheduler nodes 140-1 through 140-n may include an instance (e.g., a software instance) that further includes functionality for causing the execution of tasks by an execution system, as described in further detail below, including reading the contents of, and writing their host:port to, a same memory location(s) of shared memory 120. In one implementation, the scheduler nodes 140-1 through 140-n may each be implemented as a microservice. Scheduler system 110 is shown as a single system connected to network 105, but may include multiple different systems 110 located at different distributed locations and connected to network 105. Scheduler nodes 140-1 through 140-n (referred to herein as “scheduler node 140” or “scheduler nodes 140”) may be located within a single scheduler system 110 in network 105, or may be distributed across multiple scheduler systems 110.

Shared memory 120 includes at least one network device having memory storage that is accessible by each of the scheduler nodes 140 of scheduler system 110 (i.e., scheduler nodes 140 have shared access to shared memory 120). A particular memory location (or group of memory locations) of the memory storage may be accessed by each of the scheduler nodes 140 to read data from, or to write data to, the memory location(s). When a scheduler node 140 writes data to the shared memory 120 (e.g., writes its host:port), data previously stored in the shared memory 120 is overwritten. Therefore, shared memory 120 only stores the host:port of the scheduler node 140 that has most recently written its data into the shared memory 120. A last scheduler node 140 that writes its host:port in shared memory 120 is identified as the current primary scheduling node for scheduling a task of batch job 150 stored at execution system 130.

Execution system 130 may include at least one network device that further includes memory storage resources for storing a batch job 150 and processing resources for executing tasks of the batch job. Each batch job 150 may include a sequence of tasks T1, T2, . . . Tm that are stored in a task queue (not shown—described below). Execution system 130 executes each sequential task in batch job 150 based on an instruction/command received from a scheduler node 140 currently identified as a primary scheduler node within shared memory 120.

The configuration of components of network environment 100 in FIG. 1 is for illustrative purposes. Other configurations may be implemented. Therefore, network environment 100 may include additional, fewer, and/or different components/devices/networks which may be configured in a different arrangement from that depicted in FIG. 1.

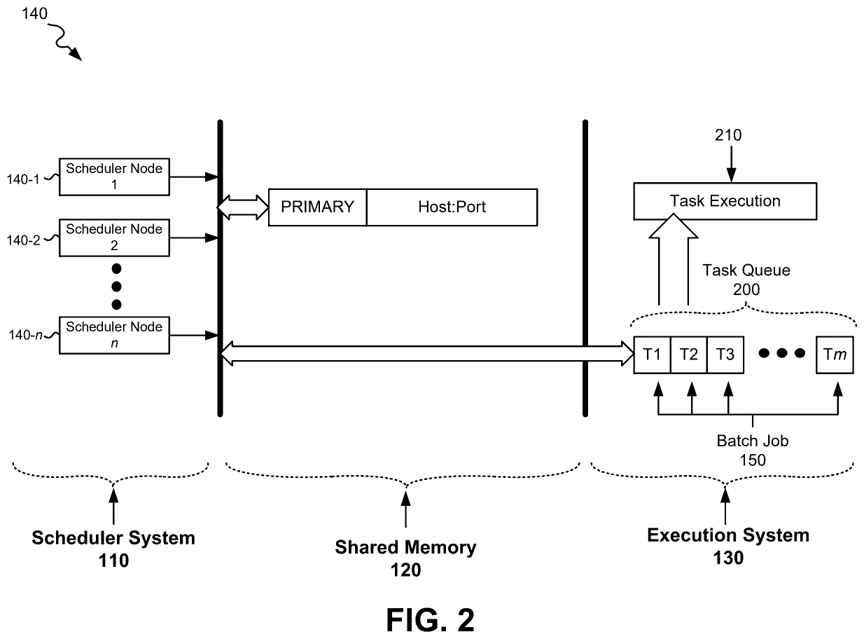

FIG. 2 illustrates the inter-operation of the components of distributed system 140 for scheduling the execution of tasks of batch job 150. During each interval, scheduler nodes 140-1 through 140-n may, on a first-come, first-served basis across network 105 (not shown), write their host:port into shared memory 120, overwriting any previous scheduler node 140's host:port. At the end of each interval, a last scheduler node 140 will have written its host:port into shared memory 120, and that scheduler node 140 may be designated the “primary” scheduler node for purposes of executing a task stored at execution system 130.

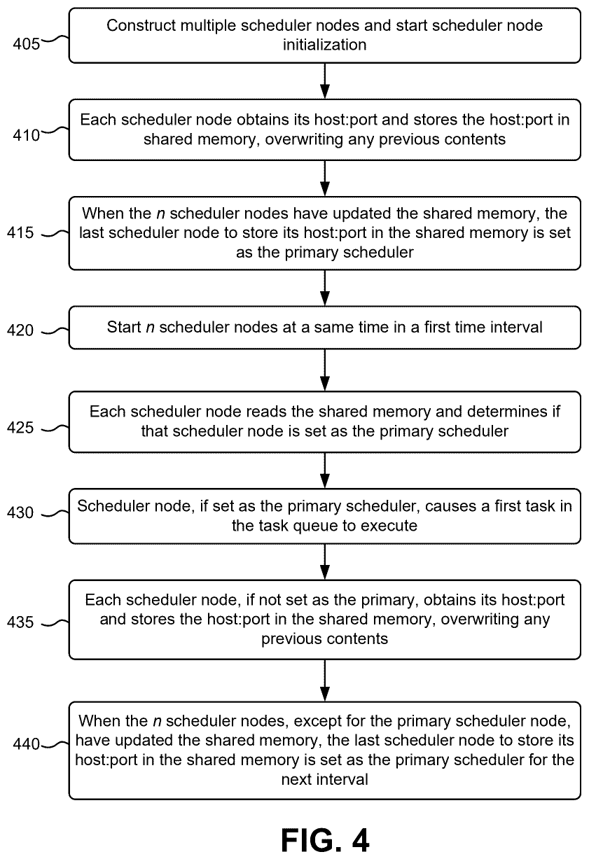

As shown, execution system 130 may include a task queue 200 that stores m sequential tasks [T1, T2, T3, . . . , Tm] of batch job 150 (where m is any integer greater than or equal to two). When a scheduler node 140 has been designated as the primary scheduler node, then that scheduler node 140 may, as described further herein, command execution system 130 to perform task execution 210 upon a next task stored in task queue 200. For example, if task T3 was the task of batch job 150 executed by execution system 130 in a previous interval, then a scheduler node 140 currently designated as a primary scheduler node may command execution system 130 to perform task execution 210 upon a next task T4. Therefore, during each of a series of intervals, a scheduler node 140, currently designated as the “primary scheduler,” may cause execution system 130 to begin task execution 210 of a next task in the batch job stored in task queue 200. Further example details of scheduler node initialization and prioritization are described below with respect to FIGS. 4-12.

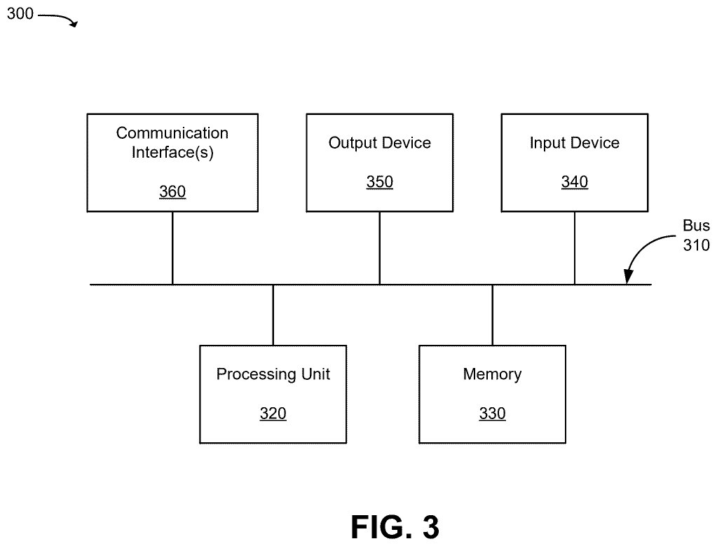

FIG. 3 is a diagram that depicts example components of a network device 300 (referred to herein as a “network device” or a “device”). Scheduler system 110, shared memory 120, and execution system 130 may each be implemented by one or more network devices having components that are the same as, or similar to, those of device 300 shown in FIG. 3. A network device(s) 300 implementing scheduler system 110, another network device 300 implementing shared memory 120, and an additional network device(s) 300 implementing execution system 130 may be distributed with respect to one another (i.e., located remotely from one another) such that the various network devices 300 communicate across network 105 to send data to, or receive data from, one another.

Device 300 may include a bus 310, a processing unit 320, a memory 330, an input device 340, an output device 350, and a communication interface 360. Bus 310 may include a path that permits communication among the components of device 300. Processing unit 320 may include one or more processors or microprocessors which may interpret and execute instructions, or processing logic. Memory 330 may include one or more memory devices for storing data and instructions. Memory 330 may include a random access memory (RAM) or another type of dynamic storage device that may store information and instructions for execution by processing unit 320, a Read Only Memory (ROM) device or another type of static storage device that may store static information and instructions for use by processing unit 420, and/or a magnetic, optical, or flash memory recording and storage medium. The memory devices of memory 330 may each be referred to herein as a “tangible non-transitory computer-readable medium,” “non-transitory computer-readable medium,” or “non-transitory storage medium. ” In some implementations, the processes/methods, or portions (e.g., one or more blocks) of the process/methods, set forth herein can be implemented as instructions that are stored in memory(ies) 330 for execution by processing unit(s) 320 of one or more network devices 300.

Input device 340 may include one or more mechanisms that permit an operator to input information into device 300, such as, for example, a keypad or a keyboard, a display with a touch sensitive panel, voice recognition and/or biometric mechanisms, etc. Output device 350 may include one or more mechanisms that output information to the operator, including a display, a speaker, etc. Input device 340 and output device 350 may, in some implementations, be implemented as a user interface (UI) that displays UI information and which receives user input via the UI. Communication interface 360 may include a transceiver(s) that enables device 300 to communicate with other devices and/or systems. For example, communication interface 360 may include one or more wired and/or wireless transceivers for communicating via network 105.

The configuration of components of network device 300 illustrated in FIG. 3 is for illustrative purposes. Other configurations may be implemented. Therefore, network device 300 may include additional, fewer and/or different components, which may be arranged in a different configuration, than depicted in FIG. 3.

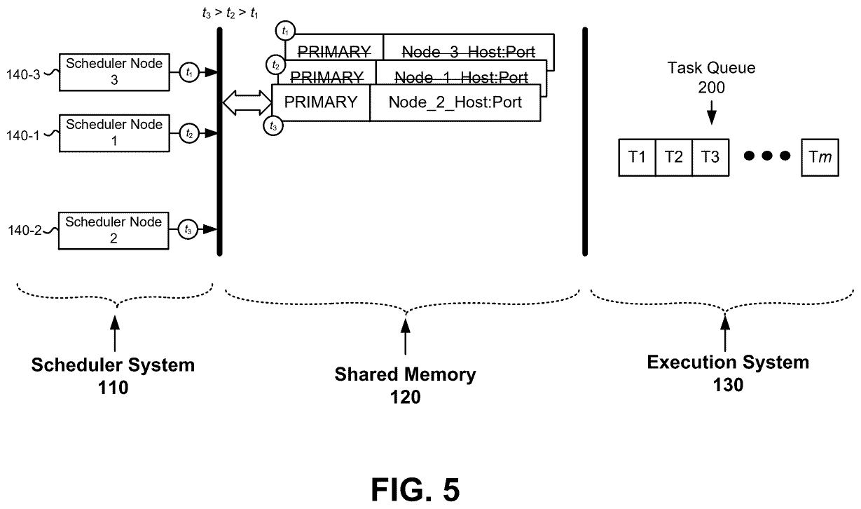

FIG. 4 illustrates an example process for initializing scheduler nodes 140 of scheduler system 110, and shared memory 120. The process of FIG. 4 may be implemented, for example, by scheduler nodes 140-1 through 140-n, and is described below with reference to the example diagrams of FIGS. 5-7. Though the process of FIG. 4 is described as being performed by scheduler nodes 140-1 through 140-n, the process may alternatively, or additionally, either partially or entirely, be performed by another network device, node, or entity connected to network 105.

The example process includes constructing multiple (n) scheduler nodes and starting scheduler node initialization (block 405). A system operator, or other entity, may construct n scheduler nodes by installing and configuring the n scheduler nodes at one or more network devices connected to network 105. Upon successful construction completion, the n scheduler nodes may be executed to begin their initialization.

Each of the n scheduler nodes obtains its host:port and stores the host:port in shared memory 120, overwriting any previous contents stored in shared memory 120 (block 410). Each scheduler node has a host network address (i.e., the network address of the network device hosting the scheduler node 140) and a corresponding port number of the scheduler node 140 at that host network address. The port number may be used to map incoming data from the port number to a particular scheduler node 140 executing at the network device. As an example, the host:port for a given scheduler node 140 may include an Internet Protocol address, 20.250.210.33, separated by a colon with the port number 325 assigned to the scheduler node 140 (e.g., host:port=20.250.210.33:325). At the start of scheduler node initialization, each scheduler node 140 attempts to write its host:port into shared memory 120 (also referred to herein as “updating shared memory 120”) and, if no other scheduler node 140 is currently accessing the shared memory 120, then each scheduler node 140 writes its host:port into shared memory 120, overwriting any previous scheduler node 140's host:port already stored there. If, when a scheduler node 140 attempts to write to shared memory 120 and finds that another scheduler node 140 is already accessing shared memory 120, then the scheduler node 140 backs off a period of time, and makes the attempt again. FIG. 5 depicts a simplified example in which scheduler nodes 140-1 through 140-3 have updated shared memory 120. As illustrated in FIG. 5, scheduler node 140-3 first stores its host:port in shared memory 120 at t₁, followed by scheduler node 140-1 storing its host:port in shared memory 120 at time t₂ (where t₂>t₁), overwriting node 140-3's host:port previously written into memory 120. Subsequently, scheduler node 140-2 stores its host:port in shared memory 120 at time t₃ (where t₃>t₂>t₁), overwriting node 140-1's host:port previously written into memory 120.

When the n scheduler nodes have updated the shared memory, the last scheduler node 140 to store its host:port in the shared memory is set as the primary scheduler (block 415). Over the first interval, during initialization, all n scheduler nodes may write their host:port into shared memory 120, overwriting any previous data written into shared memory 120. A last scheduler node 140 that writes its host:port into shared memory 120 during the initialization interval is designated as the primary scheduler node 140 for initiating execution of a first task, in task queue 200, of batch job 150. Since, in the simplified example of FIG. 5, scheduler node 140-2 is the last scheduler node 140 to update shared memory 120, then scheduler node 140-2 is designated as the primary scheduler node for executing the first task T1.

The n scheduler nodes 140 are started at a same time in a same first time interval (block 420), and each scheduler node 140 reads the shared memory and determines if that scheduler node 140 is set as the primary scheduler (block 425). A controlling node, associated with shared memory 120 or scheduler system 110, or one of the scheduler nodes 140, may keep track of how many of the n scheduler nodes 140 have updated shared memory 120 (i.e., by writing their host:port into shared memory 120). When all n scheduler nodes 140 have updated shared memory 120, then the controlling node or the scheduler node 140 may issue a command to all of the scheduler nodes 140 instructing them to begin a first interval by each reading the shared memory 120 to identify which scheduler node 140 has its host:port currently stored in shared memory 120 as the primary scheduler node. Each scheduler node 140 performs a read operation upon shared memory 120 to identify whether that scheduler node 140 is currently the primary scheduler node. If a scheduler node 140, upon performing the read operation of shared memory 120 and determining that it is not currently the primary scheduler node, waits until all n scheduler nodes 140 have performed the shared memory 120 read operation and then proceeds to block 435 below.

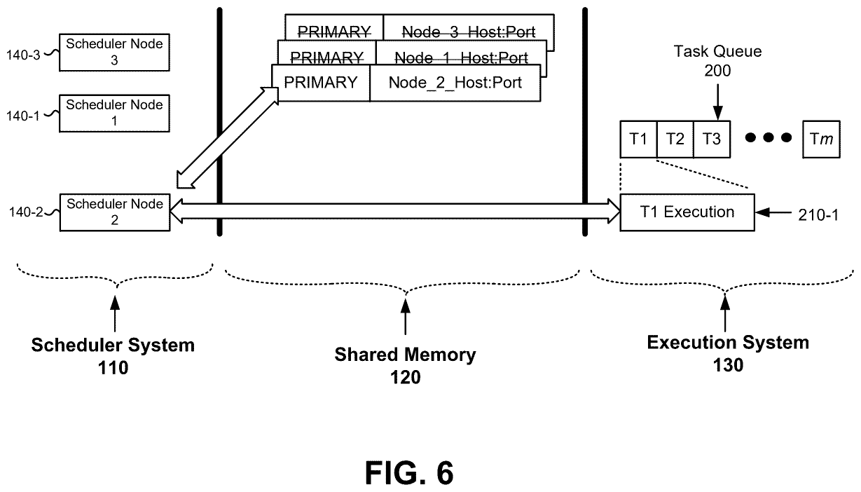

A scheduler node 140, if set as the primary scheduler, causes a first task, stored in the task queue 200, of a batch job 150 to execute (block 430). The scheduler node 140, set as the primary scheduler in shared memory 120, sends a command to execution system 130 to cause system 130 to retrieve task T1 of batch job 150 from task queue and to perform task execution 210 of the task. Referring to the simplified example depicted in FIG. 6, when scheduler node 140-2 reads shared memory 120, node 140-2 determines that its host:port is stored there and, therefore, that node 140-2 is the primary scheduler node. Consequently, as shown in FIG. 6, scheduler node 140-2 causes execution system 130 to retrieve task T1 from task queue 200 and perform T1 execution 210-1.

Each scheduler node 140, if not set as the primary scheduler, obtains its host:port and stores the host:port in the shared memory 120, overwriting any previous contents (block 435).

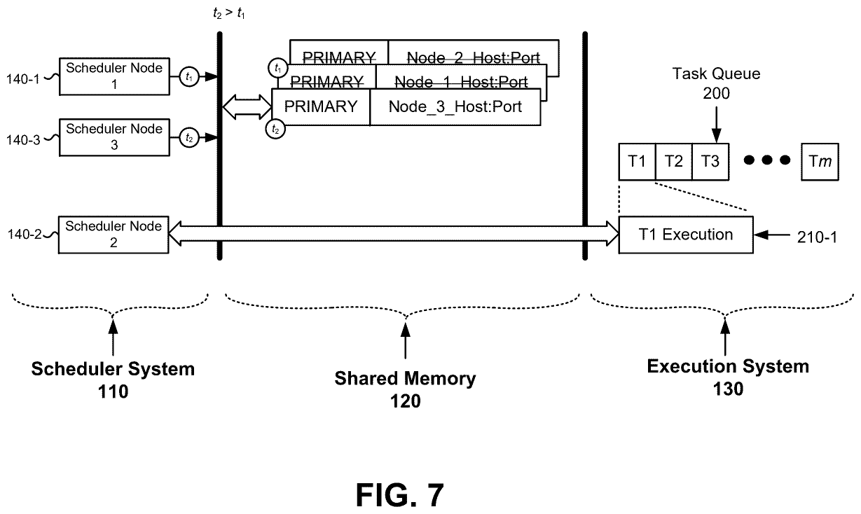

Once the primary scheduler node 140 sends the command to cause the first task of batch job 150 to execute, each of the non-primary scheduler nodes 140, in a first-come, first-served manner, stores their host:port in shared memory 120, overwriting any previous contents. The simplified example of FIG. 7 shows scheduler node 140-2 continuing its involvement with execution system 130 performing T1 execution 210-1, while scheduler node 140-1 writes its host:port into shared memory 120 at time t₁, overwriting the previous contents of shared memory 120. FIG. 7 further depicts scheduler 140-3 writing its host:port into shared memory 120 at time t₂ (where t₂>t₁), overwriting the host:port data previously stored there by scheduler node 140-1.

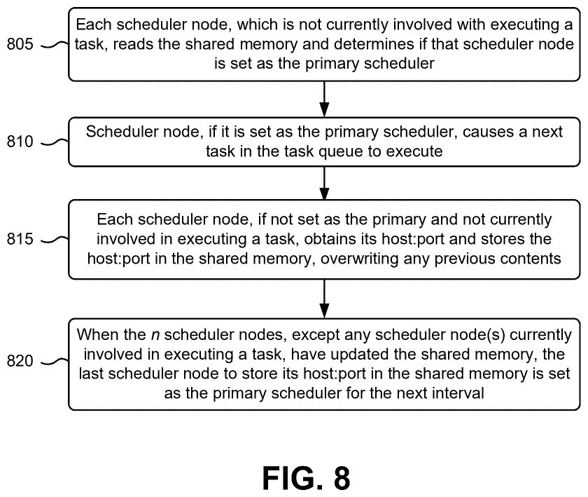

When the n scheduler nodes, except for the primary scheduler node, have updated the shared memory, the last scheduler node to store its host:port in the shared memory is set as the primary scheduler for the next interval (block 440). A controlling node, associated with shared memory 120 or scheduler system 110, or one of the scheduler nodes 140, may keep track of which scheduler nodes 140, of the n scheduler nodes 140, have updated shared memory 120 (i.e., by writing their host:port into shared memory 120). When all n scheduler nodes 140, except for the primary scheduler node, have updated shared memory 120, then the last scheduler node 140 to store its host:port in shared memory 120 is set as the primary scheduler for the next interval, and the controlling node or the scheduler node 140 may then trigger the execution of the process of FIG. 8, which involves scheduler node prioritization for task execution for subsequent intervals after the first interval until the mth task of batch job 150 in task queue 200 is completed. In the simplified example of FIG. 7, scheduler node 140-3 is the last node to update shared memory 120 within the first interval and, therefore, will be the primary scheduler node for the second interval, which is described below with respect to the process of FIG. 8.

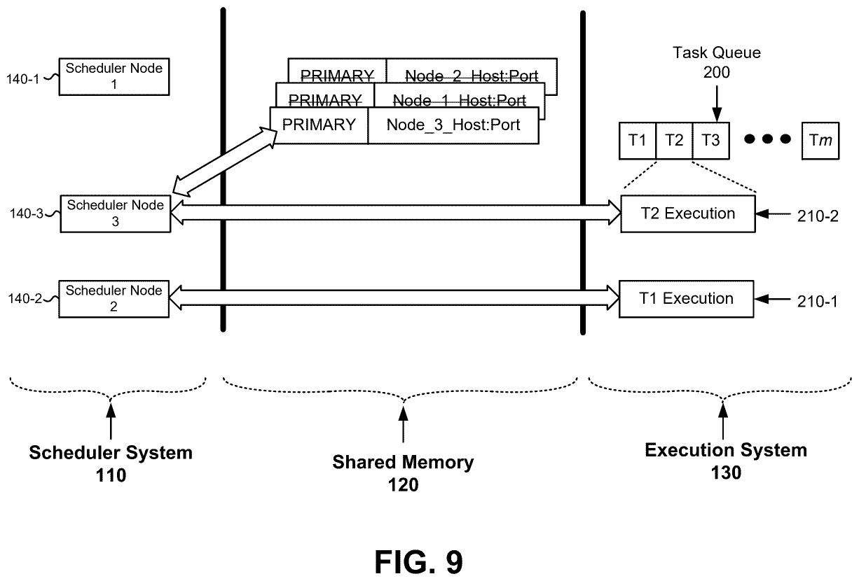

FIG. 8 illustrates an example process for prioritizing the operation of scheduler nodes 140 for executing tasks of batch job 150 stored in task queue 200 for an interval x (after the first interval described with respect to blocks 420-440 above). The process of FIG. 8 may be implemented, for example, by scheduler nodes 140-1 through 140-n and is described below with reference to the example diagrams of FIGS. 9-12. Though the process of FIG. 8 is described as being performed by scheduler nodes 140-1 through 140-n, the process may be alternatively, or additionally, and either partially or entirely performed by another network device, node, or entity connected to network 105.

The example process includes each scheduler node 140, which is not currently involved with executing a task, reading the shared memory 120 and determining if that scheduler node 140 is set as the primary scheduler (block 805). Each scheduler node 140, that is not currently involved with executing a task of batch job 150, performs a read operation upon shared memory 120 to identify whether that scheduler node 140 is currently the primary scheduler node. Upon performing the read operation of shared memory 120 and determining that it is not currently the primary scheduler node, the scheduler node 140 waits until all other of the n scheduler nodes 140, which are not currently involved in executing a task, have performed the shared memory 120 read operation and then proceeds to block 715 below.

A scheduler node 140, if it is set as the primary scheduler, causes a next task in the task queue 200 to execute (block 810). The scheduler node 140, set as the primary scheduler in shared memory 120, sends a command to execution system 130 to cause system 130 to retrieve a next task Tx of batch job 150 from task queue 200 and to perform task execution 210 of the task. In the simplified example of FIG. 8, scheduler node 140-2 continues to be involved, in conjunction with execution system 130, with performing T1 execution 210-1, as previously described with respect to FIG. 7 above. As further shown in FIG. 9, scheduler node 140-3 reads shared memory 120 and determines that node 140-3 is currently designated as the primary scheduler node. Consequently, as shown in FIG. 9, scheduler node 140-3 causes execution system 130 to retrieve task T2 from task queue 200 and perform T2 execution 210-2.

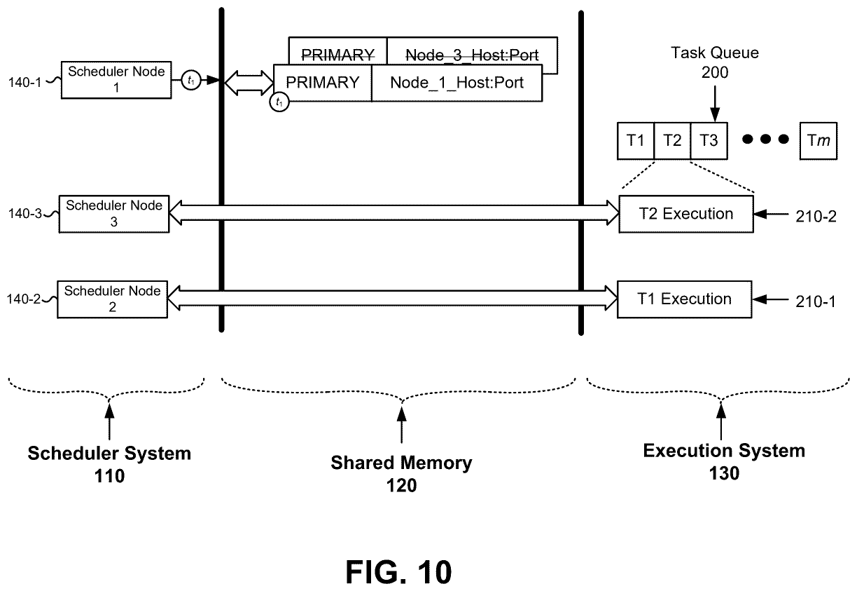

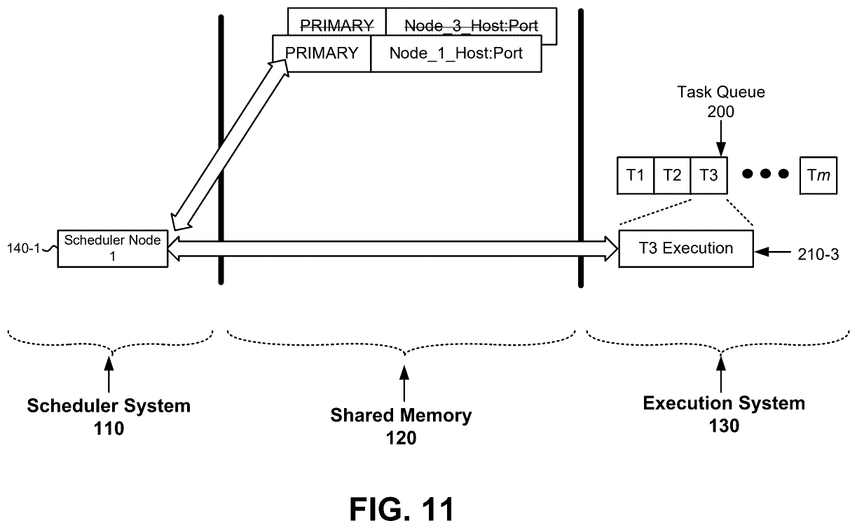

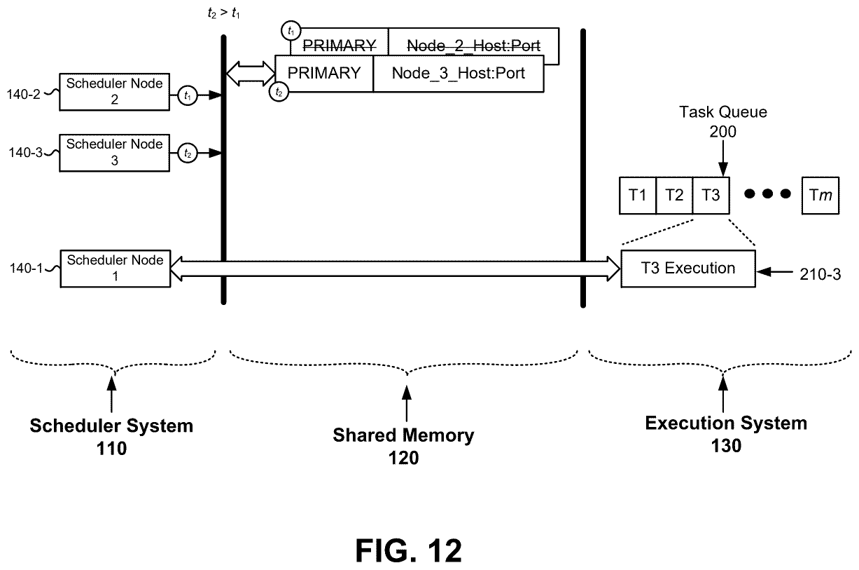

Each scheduler node 140, if not set as the primary and not currently involved in executing a task, obtains its host:port and stores the host:port in the shared memory 120, overwriting any previous contents (block 815). When the n scheduler nodes, except any scheduler node(s) currently involved in executing a task, have updated the shared memory 120, the last scheduler node 140 to store its host:port in the shared memory 120 is set as the primary scheduler for the next interval (block 820). Once the primary scheduler node 140 sends the command to cause a next task Tx of batch job 150 to execute, each of the non-primary scheduler nodes 140, in a first-come, first-served manner, stores their host:port in shared memory 120, overwriting any previous contents. In the simplified example of FIG. 10, scheduler node 140-1, since it is not currently involved in executing a task, stores its host:port in shared memory 120 and, as the last (and only, in this simplified example) scheduler node to update shared memory 120, becomes the primary scheduler node for the next interval. A controlling node, associated with shared memory 120 or scheduler system 110, or one of the scheduler nodes 140, may keep track of which scheduler nodes 140, of the n scheduler nodes 140, have updated shared memory 120 (i.e., by writing their host:port into shared memory 120). When all n scheduler nodes 140, except for any scheduler node 140 currently involved in executing a task, have updated shared memory 120, then the last scheduler node 140 that stores its host:port in shared memory 120 is set as the primary scheduler for a next interval x. The controlling node or the scheduler node 140 may then trigger the execution of a next interval, which involves repeating blocks 805-820 of FIG. 8 for executing a next task of batch job 150 stored in task queue 200. The example process of FIG. 8 may be repeated for each subsequent interval after the first interval (i.e., the initialization interval when the blocks of FIG. 4 execute) and may continue repeating until all of the m tasks of the batch job 150 stored in the task queue 200 have completed their execution. Returning to the simplified example of FIG. 11, scheduler nodes 140-2 and 140-3 have completed their involvement with the execution of T1 and T2 (as shown in FIG. 10) and scheduler node 140-1 reads shared memory 120 to determine that node 140-1's host:port is currently stored in shared memory 120. As the primary scheduler node for the current interval, and as can be seen in FIG. 11, scheduler node 140-1 causes execution system 130 to retrieve task T3 from task queue 200 and perform T3 execution 210-3. Proceeding to the simplified example of FIG. 12, scheduler nodes 140-2 and 140-3, since they are not currently involved in executing tasks, store their host:port in shared memory 120 on a first-come, first-served basis. As shown, scheduler node 140-2, at time t₁, stores its host:port in shared memory 120 and subsequently, at time t₂, scheduler node 140-3 stores its host:port in shared memory 120. Being the last update to shared memory, scheduler node 140-3 becomes the primary scheduler node for the next interval.

The foregoing description of implementations provides illustration and description, but is not intended to be exhaustive or to limit the invention to the precise form disclosed. Modifications and variations are possible in light of the above teachings or may be acquired from practice of the invention. For example, while series of blocks have been described with respect to FIGS. 4 and 8, and sequences of operations with respect to FIGS. 5-7, and 9-12, the order of the blocks and/or the may be varied in other implementations. Moreover, non-dependent blocks may be performed in parallel.

Certain features described above may be implemented as “logic” or a “unit” that performs one or more functions. This logic or unit may include hardware, such as one or more processors, microprocessors, application specific integrated circuits, or field programmable gate arrays, software, or a combination of hardware and software.

Embodiments have been described without reference to the specific software code because the software code can be designed to implement the embodiments based on the description herein and commercially available software design environments and/or languages. For example, various types of programming languages including, for example, a compiled language, an interpreted language, a declarative language, or a procedural language may be implemented.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processing unit 315) of a device. A non-transitory storage medium includes one or more of the storage mediums described in relation to memory/storage 330/350. The non-transitory computer-readable storage medium may be implemented in a centralized, distributed, or logical division that may include a single physical memory device or multiple physical memory devices spread across one or multiple network devices.

To the extent the aforementioned embodiments collect, store or employ personal information of individuals, such information shall be collected, stored, and used in accordance with all applicable laws concerning protection of personal information. Additionally, the collection, storage and use of such information can be subject to consent of the individual to such activity, for example, through well known “opt-in” or “opt-out” processes as can be appropriate for the situation and type of information. Collection, storage and use of personal information can be in an appropriately secure manner reflective of the type of information, for example, through various encryption and anonymization techniques for particularly sensitive information.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

All structural and functional equivalents to the elements of the various aspects set forth in this disclosure that are known or later come to be known to those of ordinary skill in the art are expressly incorporated herein by reference and are intended to be encompassed by the claims.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A system, comprising:
a task queue that stores multiple tasks of a batch job; and
a scheduler comprising multiple scheduler nodes which, on a first-come, first-served basis during a first interval, write their network address and port number to a same memory location of a shared memory storage, while overwriting any previous network address and port number written to the same memory location,
wherein a last one of the multiple scheduler nodes to write its network address and port number to the same memory location during the first interval is designated as a first primary scheduler and commands an execution system to perform task execution upon a first task of the batch job stored in the task queue.

2. The system of claim 1, wherein, subsequent to the multiple scheduler nodes writing their network address and port number to the same memory location of the shared memory storage during the first interval, the multiple scheduler nodes, on a first-come, first-served basis, read the same memory location of the shared memory storage to determine which of the multiple scheduler nodes is designated as the first primary scheduler.

3. The system of claim 1, wherein the scheduler system and the execution system are located at distributed locations in a network.

4. The system of claim 1, wherein the multiple scheduler nodes, on a first-come, first-served basis and except for the first primary scheduler involved in executing the first task, write their network address and port number to the same memory location of the shared memory storage, while overwriting any previous network address and port number written to the same memory location,
wherein a last one of the multiple scheduler nodes to write its network address and port number to the same memory location is designated as a second primary scheduler and commands the execution system to perform task execution upon a second task of the batch job stored in the task queue.

5. The system of claim 4, wherein, subsequent to the multiple scheduler nodes writing their network address and port number to the same memory location of the shared memory storage, the multiple scheduler nodes, on a first-come, first-served basis, read the same memory location of the shared memory storage to determine which of the multiple scheduler nodes is designated as the second primary scheduler.

6. The system of claim 4, wherein the multiple scheduler nodes, on a first-come, first-served basis and except for the second primary scheduler involved in executing the second task, write their network address and port number to the same memory location of the shared memory storage, during a second interval, while overwriting any previous network address and port number written to the same memory location,
wherein a last one of the multiple scheduler nodes to write its network address and port number to the same memory location during the second interval is designated as the second primary scheduler and commands the execution system to perform task execution upon a second task of the batch job stored in the task queue.

7. The system of claim 1, wherein each of the multiple scheduler nodes comprises a software instance that includes functionality for scheduling execution of the multiple tasks of the batch job.

8. The system of claim 1, wherein each of the multiple scheduler nodes comprises a microservice.

9. A method, comprising:
storing multiple tasks of a batch job in a task queue;
implementing a scheduler comprising multiple scheduler nodes, wherein the multiple scheduler nodes further, on a first-come, first-served basis, write their network address and port number to a same memory location of a shared memory storage, during a first interval, while overwriting any previous network address and port number written to the same memory location; and
designating a last one of the multiple scheduler nodes to write its network address and port number to the same memory location during the first interval as a first primary scheduler, wherein the first primary scheduler further commands an execution system to perform task execution upon a first task of the batch job stored in the task queue.

10. The method of claim 9, wherein, subsequent to the multiple scheduler nodes writing their network address and port number to the same memory location of the shared memory storage during the first interval,
reading, by the multiple scheduler nodes on a first-come, first-served basis, the same memory location of the shared memory storage to determine which of the multiple scheduler nodes is designated as the first primary scheduler.

11. The method of claim 9, wherein the scheduler and the execution system are located at distributed locations in a network.

12. The method of claim 9, further comprising:
writing, by the multiple scheduler nodes on a first-come, first-served basis and except for the first primary scheduler involved in executing the first task, their network address and port number to the same memory location of the shared memory storage, while overwriting any previous network address and port number written to the same memory location; and
designating a last one of the multiple scheduler nodes to write its network address and port number to the same memory location as a second primary scheduler, wherein the second primary scheduler further commands the execution system to perform task execution upon a second task of the batch job stored in the task queue.

13. The method of claim 12, further comprising:
reading, by the multiple scheduler nodes on a first-come, first-served basis subsequent to writing their network address and port number to the same memory location of the shared memory storage, the same memory location of the shared memory storage to determine which of the multiple scheduler nodes is designated as the second primary scheduler.

14. The method of claim 12, further comprising:
writing, by the multiple scheduler nodes on a first-come, first-served basis and except for the second primary scheduler involved in executing the second task, their network address and port number to the same memory location of the shared memory storage, during a second interval, while overwriting any previous network address and port number written to the same memory location; and
designating a last one of the multiple scheduler nodes to write its network address and port number to the same memory location during the second interval as the second primary scheduler, wherein the second primary scheduler commands the execution system to perform task execution upon a second task of the batch job stored in the task queue.

15. The method of claim 9, wherein each of the multiple scheduler nodes comprises a software instance that includes functionality for scheduling execution of the multiple tasks of the batch job.

16. The method of claim 9, wherein each of the multiple scheduler nodes comprises a microservice.

17. A distributed system, comprising:
a task queue that stores multiple tasks of a batch job;
a shared memory storage;
an execution system; and
a scheduler located at a distributed location relative to the task queue, the execution system, and the shared memory storage,
wherein the scheduler comprises multiple scheduler nodes which, on a first-come, first-served basis during a first interval, write their network address and port number to a same memory location of the shared memory storage, while overwriting any previous network address and port number written to the same memory location,
wherein, subsequent to the multiple scheduler nodes writing their network address and port number to the same memory location of the shared memory storage, the multiple scheduler nodes, on a first-come, first-served basis, read the same memory location of the shared memory storage to determine which of the multiple scheduler nodes was the last of the multiple scheduler nodes to write its network address and port number to the same memory location during the first interval and is designated as a first primary scheduler, and
wherein the first primary scheduler commands the execution system to perform task execution upon a first task of the batch job stored in the task queue.

18. The system of claim 17, wherein the multiple scheduler nodes, on a first-come, first-served basis and except for the first primary scheduler involved in executing the first task, write their network address and port number to the same memory location of the shared memory storage, while overwriting any previous network address and port number written to the same memory location,
wherein, subsequent to the multiple scheduler nodes writing their network address and port number to the same memory location of the shared memory storage, the multiple scheduler nodes, on a first-come, first-served basis, read the same memory location of the shared memory storage to determine which of the multiple scheduler nodes is designated as a second primary scheduler, and
wherein the second primary scheduler commands the execution system to perform task execution upon a second task of the batch job stored in the task queue.

19. The distributed system of claim 17, wherein each of the multiple scheduler nodes comprises a microservice.

20. The distributed system of claim 17, wherein each of the multiple scheduler nodes comprises a software instance that includes functionality for scheduling execution of the multiple tasks of the batch job.
